(19) United States
(12) Patent Application Publication
(10) Pub. No.: US 2021/0248563 A1
(43) Pub. Date: Aug. 12, 2021

(54) APPARATUS, METHOD, AND PROGRAM PRODUCT FOR INDICATING MEETING PREFERENCES

(71) Applicant: LENOVO (Singapore) PTE. LTD., New Tech Park (SG)

(72) Inventors: Arnold S. Weksler, Raleigh, NC (US); John Carl Mese, Cary, NC (US); Russell Speight VanBlon, Raleigh, NC (US); Mark Patrick Delaney, Raleigh, NC (US); Nathan J. Peterson, Oxford, NC (US)

(21) Appl. No.: 16/786,739

(22) Filed: Feb. 10, 2020

(51) Int. Cl. G06Q 10/10; G06Q 10/06

(52) U.S. Cl. CPC G06Q 10/1095; G06Q 10/107; G06Q 10/06314; G06Q 10/06311

(57) ABSTRACT

Apparatuses, methods, and program products are disclosed for indicating meeting preferences. One apparatus includes a processor and a memory that stores code executable by the processor. The code is executable by the processor to determine, by use of the processor, meeting preferences corresponding to a user of a calendar software application. The code is executable by the processor to store information indicating the meeting preferences corresponding to the user in the calendar software application. The code is executable by the processor to display the information indicating the meeting preferences corresponding to the user in the calendar software application.

### FIELD

The subject matter disclosed herein relates to electronic calendars and more particularly relates to indicating meeting preferences in the electronic calendars.

### BACKGROUND

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for performing various actions. Certain information handling devices may be used to manage digital calendars. Digital calendars may be used to schedule meetings.

### BRIEF SUMMARY

An apparatus for indicating meeting preferences is disclosed. A method and computer program product also perform the functions of the apparatus. In one embodiment, the apparatus includes a processor and a memory that stores code executable by the processor. The code, in various embodiments, is executable by the processor to determine, by use of the processor, meeting preferences corresponding to a user of a calendar software application. The code, in certain embodiments, is executable by the processor to store information indicating the meeting preferences corresponding to the user in the calendar software application. The code, in some embodiments, is executable by the processor to display the information indicating the meeting preferences corresponding to the user in the calendar software application.

In some embodiments, the code is executable by the processor to determine the meeting preferences corresponding to the user by determining a likelihood that the user will accept a meeting invitation for a date, a day, a time, a location, or some combination thereof. In one embodiment, the code is executable by the processor to determine the likelihood that the user will accept a meeting invitation for a date, a day, a time, a location, or a combination thereof by determining the likelihood that the user will accept a meeting invitation for a date, a day, a time, a location, or some combination thereof based on historical patterns corresponding to the user.

In various embodiments, the code is executable by the processor to determine the likelihood that the user will accept a meeting invitation for a date, a day, a time, a location, or a combination thereof by determining the likelihood that the user will accept a meeting invitation for a date, a day, a time, a location, or some combination thereof based on historical meeting acceptance data corresponding to the user. In some embodiments, the code is executable by the processor to determine the likelihood that the user will accept a meeting invitation for a date, a day, a time, a location, or a combination thereof by determining the likelihood that the user will accept a meeting invitation for a date, a day, a time, a location, or some combination thereof based on settings selected by the user.

A method for indicating meeting preferences, in one embodiment, includes determining, by use of a processor, meeting preferences corresponding to a user of a calendar software application. In certain embodiments, the method includes storing information indicating the meeting preferences corresponding to the user in the calendar software application. In some embodiments, the method includes displaying the information indicating the meeting preferences corresponding to the user in the calendar software application.

In some embodiments, determining the meeting preferences corresponding to the user includes determining a likelihood that the user will accept a meeting invitation for a date, a day, a time, a location, or some combination thereof. In various embodiments, determining the likelihood that the user will accept a meeting invitation for a date, a day, a time, a location, or a combination thereof includes determining the likelihood that the user will accept a meeting invitation for a date, a day, a time, a location, or some combination thereof based on historical meeting acceptance data corresponding to the user. In one embodiment, determining the likelihood that the user will accept a meeting invitation for a date, a day, a time, a location or some combination thereof includes determining the likelihood that the user will accept a meeting invitation for a date, a day, a time, a location or some combination thereof based on settings selected by the user. In some embodiments, determining the meeting preferences corresponding to the user includes determining the meeting preferences heuristically. In certain embodiments, displaying the information indicating the meeting preferences corresponding to the user in the calendar software application includes displaying the information using a color indicator to indicate a likelihood that the user will accept a meeting invitation for a date, a day, a time, a location, or some combination thereof.

In some embodiments, displaying the information indicating the meeting preferences corresponding to the user in the calendar software application includes displaying the information using a numeric indicator, an alphabetic indicator, or a combination thereof to indicate a likelihood that the user will accept a meeting invitation for a date, a day, a time, a location, or some combination thereof. In various embodiments, the method includes scheduling a meeting for the user based at least partly on the information. In certain embodiments, scheduling the meeting for the user based at least partly on the information includes indicating a recommended meeting date, a recommended meeting day, a recommended meeting time, a recommended meeting location, or some combination thereof based at least partly on the information. In some embodiments, the meeting preferences include date preferences, day preferences, time preferences, location preferences, or some combination thereof. In various embodiments, the method includes sharing the information indicating the meeting preferences corresponding to the user in the calendar software application with other users of the calendar software application.

In one embodiment, a program product includes a computer readable storage medium that stores code executable by a processor. The executable code, in certain embodiments, includes code to perform determining, by use the processor, meeting preferences corresponding to a user of a calendar software application. The executable code, in various embodiments, includes code to perform storing information indicating the meeting preferences corresponding to the user in the calendar software application. The executable code, in some embodiments, includes code to perform displaying the information indicating the meeting preferences corresponding to the user in the calendar software application.

In certain embodiments, the executable code includes code to perform displaying the information indicating the meeting preferences corresponding to the user in the calendar software application by displaying the information using a color indicator to indicate a likelihood that the user will accept a meeting invitation for a date, a day, a time, a location, or some combination thereof. In one embodiment, the executable code includes code to perform displaying the information indicating the meeting preferences corresponding to the user in the calendar software application by displaying the information using a numeric indicator, an alphabetic indicator, or a combination thereof to indicate a likelihood that the user will accept a meeting invitation for a date, a day, a time, a location, or some combination thereof. In certain embodiments, the meeting preferences include date preferences, day preferences, time preferences, location preferences, or some combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for indicating meeting preferences;

FIG. 2 is a schematic block diagram illustrating one embodiment of an apparatus including an information handling device;

FIG. 3 is a schematic block diagram illustrating one embodiment of an apparatus including an availability management module;

FIG. 4 is a schematic block diagram illustrating another embodiment of an apparatus including an availability management module;

FIG. 5 is a schematic block diagram illustrating one embodiment of a displayed calendar;

FIG. 6 is a schematic block diagram illustrating one embodiment of a calendar scheduling; and

FIG. 7 is a schematic flow chart diagram illustrating an embodiment of a method for indicating meeting preferences.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

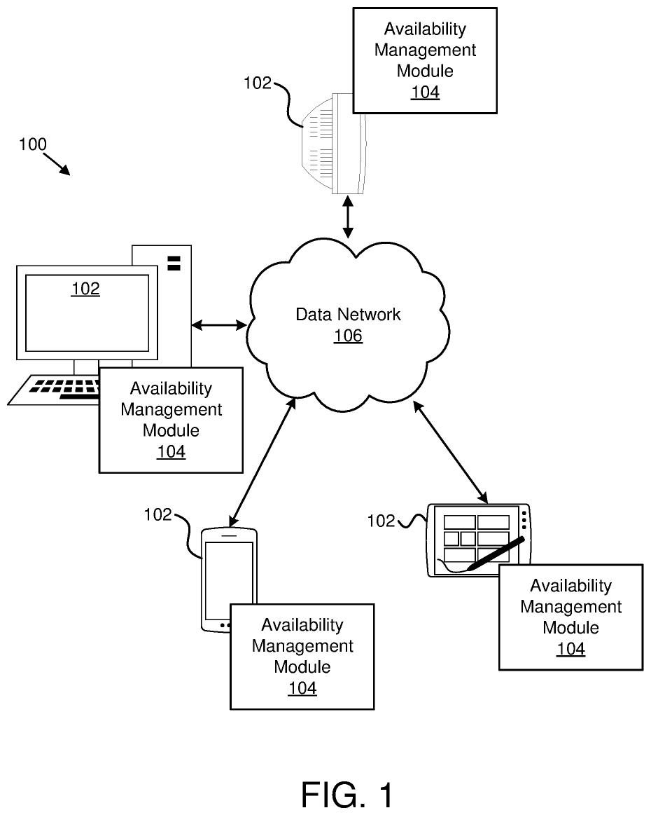

FIG. 1 depicts one embodiment of a system 100 for indicating meeting preferences. In one embodiment, the system 100 includes information handling devices 102, availability management modules 104, and data networks 106. Even though a specific number of information handling devices 102, availability management modules 104, and data networks 106 are depicted in FIG. 1, one of skill in the art will recognize that any number of information handling devices 102, availability management modules 104, and data networks 106 may be included in the system 100.

In one embodiment, the information handling devices 102 include computing devices, such as desktop computers, laptop computers, personal digital assistants (PDAs), tablet computers, smart phones, cellular phones, smart televisions (e.g., televisions connected to the Internet), set-top boxes, game consoles, security systems (including security cameras), vehicle on-board computers, network devices (e.g., routers, switches, modems), streaming devices, digital assistants (e.g., public digital assistants), or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the availability management module 104. In certain embodiments, the availability management module 104 may determine, by use of the processor, meeting preferences corresponding to a user of a calendar software application. The availability management module 104 may also store information indicating the meeting preferences corresponding to the user in the calendar software application. The availability management module 104 may display the information indicating the meeting preferences corresponding to the user in the calendar software application. In this manner, the availability management module 104 may be used for indicating meeting preferences.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

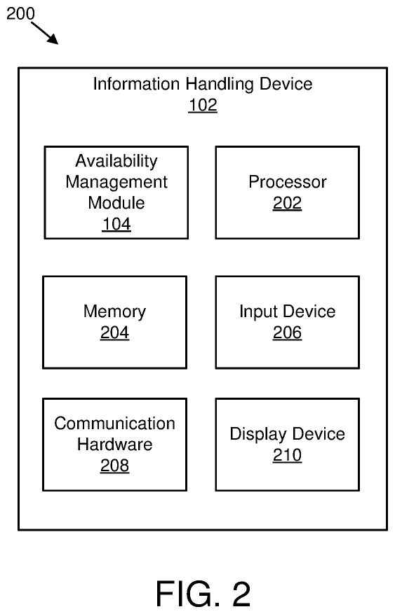

FIG. 2 depicts one embodiment of an apparatus 200 that may be used for indicating meeting preferences. The apparatus 200 includes one embodiment of the information handling device 102. Furthermore, the information handling device 102 may include the availability management module 104, a processor 202, a memory 204, an input device 206, communication hardware 208, and optionally a display device 210. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the availability management module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores configuration information. In some embodiments, the memory 204 also stores program code and related data, such as an operating system or other controller algorithms operating on the information handling device 102.

The information handling device 102 may use the availability management module 104 for indicating meeting preferences. As may be appreciated, the availability management module 104 may include computer hardware, computer software, or a combination of both computer hardware and computer software. For example, the availability management module 104 may include circuitry, or the processor 202, used to determine, by use of the processor 202, meeting preferences corresponding to a user of a calendar software application. As another example, the availability management module 104 may include computer program code that stores information indicating the meeting preferences corresponding to the user in the calendar software application. As a further example, the availability management module 104 may include computer program code that displays the information indicating the meeting preferences corresponding to the user in the calendar software application.

The input device 206, in one embodiment, may include any known computer input device including a touch panel, a button, a keyboard, a stylus, a microphone for receiving audio input (e.g., or another audio input device for receiving audio input), or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the availability management module 104.

In some embodiments, a user may want to schedule a meeting, not just based on prior scheduled meetings, but also based on a user's preferred meeting times. Described herein are various embodiments that use an availability management module 104 to configure a calendar software application to the user's preferences.

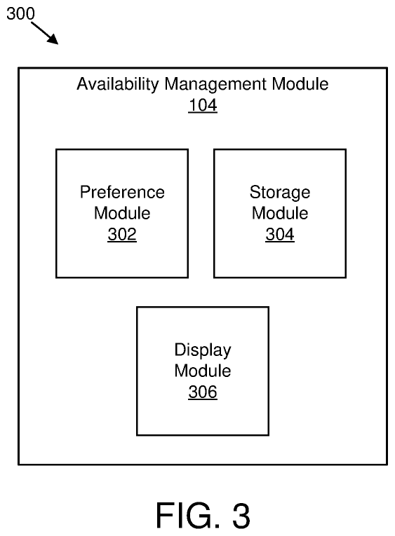

FIG. 3 depicts a schematic block diagram illustrating one embodiment of an apparatus 300 (e.g., information handling device 102) that includes one embodiment of the availability management module 104. Furthermore, the availability management module 104 includes a preference module 302, a storage module 304, and a display module 306.

In certain embodiments, the preference module 302 may determine, by use of a processor (e.g., the processor 202), meeting preferences corresponding to a user of a calendar software application. The meeting preferences may include date preferences, day preferences, time preferences, and/or location preferences for dates, times, and/or locations for which the user would prefer to have meetings. For example, the user may prefer not to have meetings before 7:00 am, after 6:00 pm, early meetings, late meetings, and/or during a lunch hour. The meeting preferences may be explicitly input by a user, or implicitly determined based on historical information and/or other data. The calendar software application may be any suitable calendar software application.

In various embodiments, determining the meeting preferences corresponding to the user may include determining a likelihood that the user will accept a meeting invitation for a date, a day, a time, and/or a location. In some embodiments, determining the likelihood that the user will accept a meeting invitation for a date, a day, a time, and/or a location includes determining the likelihood that the user will accept a meeting invitation for a date, a day, a time, and/or a location based on historical meeting acceptance data corresponding to the user. For example, the historical meeting acceptance data may be stored and/or archived data that includes information corresponding to instances for which the user has made a decision about whether to accept, decline, and/or reschedule a meeting invitation. The historical acceptance data may include a length of a meeting corresponding to the meeting invitation, a time of the meeting, a date of the meeting, a day (e.g., day of the week) of the meeting, a location of the meeting, whether the meeting has participants in different time zones, whether the meeting is scheduled for a holiday and/or weekend, a date and/or time that the user received the meeting invitation, a date and/or time that the user made the decision about whether to accept, decline, and/or reschedule the meeting, and/or the decision from the user (e.g., acceptance, decline, meeting reschedule).

In certain embodiments, determining the likelihood that the user will accept a meeting invitation for a date, a day, a time, and/or a location thereof includes determining the likelihood that the user will accept a meeting invitation for a date, a day, a time, and/or a location based on historical patterns corresponding to the user. The historical patterns may be determined and/or computed using any suitable information, such as the historical acceptance data, prior scheduled meetings, presently scheduled meetings, meeting invitations sent, and/or computer usage data. The computer usage data may include: a computer power on date, day, and/or time; a computer power off date, day, and/or time; a log in date, day, and/or time; a log off date, day, and/or time; dates, days, and/or times of high processor usage; and/or dates, days, and/or times of low processor usage.

In some embodiments, determining the likelihood that the user will accept a meeting invitation for a date, a day, a time, a location or some combination thereof includes determining the likelihood that the user will accept a meeting invitation for a date, a day, a time, a location or some combination thereof based on settings selected by the user. For example, the user may select: dates, days, times, and/or locations that the user will not accept meetings; dates, days, times, and/or locations that the user will always accept meetings; and/or dates, days, times, and/or locations that the user will be unlikely accept meetings. The user settings may indicate a likelihood of whether the user will accept a meeting invitation based on dates, days, times, and/or locations. The likelihood may be indicated by a numeric priority ranking, or using another priority ranking method. The user settings may change default settings that are preset and/or based on other factors such as calendar and/or computer usage.

In various embodiment, determining the meeting preferences corresponding to the user includes determining the meeting preferences heuristically. As may be appreciated, determining the meeting preferences heuristically may include using historical data, work schedules, vacation schedules, machine learning, artificial intelligence, trial and error, and/or other methods.

In one embodiment, the storage module 304 may store information indicating the meeting preferences corresponding to the user in the calendar software application. The meeting preferences may be stored so they can be displayed, used for scheduling meetings, used for accepting meetings, used for rejecting (e.g., declining) meetings, and/or used for rescheduling meetings.

In various embodiments, the display module 306 may display the information indicating the meeting preferences corresponding to the user in the calendar software application. The display module 306 may display the information in any suitable way. For example, displaying the information indicating the meeting preferences corresponding to the user in the calendar software application may include displaying the information using a color indicator, a numeric indicator, an alphabetic indicator and/or another indicator to indicate a likelihood that the user will accept a meeting invitation for a date, a day, a time, and/or a location. The color indicator may be a predefined color range that shows whether it is likely that a user will accept a meeting invitation and/or decline a meeting invitation. For example, the color range may include the colors of the rainbow (e.g., ROY G BIV—red, orange, yellow, green, blue, indigo, violet) in which red indicates that the user is highly likely to reject a meeting invitation, and violet indicates that the user is highly likely to accept a meeting invitation. As another example, a numeric indicator may be used. In such an example, a “1” may indicate that the user is highly likely to reject a meeting invitation, a “5” may indicate a mid-range likelihood that the user is likely to accept a meeting invitation, and a “10” may indicate that the user is highly likely to accept a meeting invitation

In certain embodiments, the availability management module 104 may facilitate scheduling a meeting for the user based at least partly on the information. In some embodiments, scheduling the meeting for the user based at least partly on the information includes indicating a recommended meeting date, a recommended meeting day, a recommended meeting time, and/or a recommended meeting location based at least partly on the information. In such embodiments, the recommendations may be displayed to the user to enable the user to select a meeting date, a meeting day, a meeting time, and/or a meeting location. In various embodiments, facilitating scheduling a meeting may include automatically scheduling a meeting based at least partly on the information.

In some embodiments, the availability management module 104 may share the information indicating the meeting preferences corresponding to the user in the calendar software application with other users of the calendar software application.

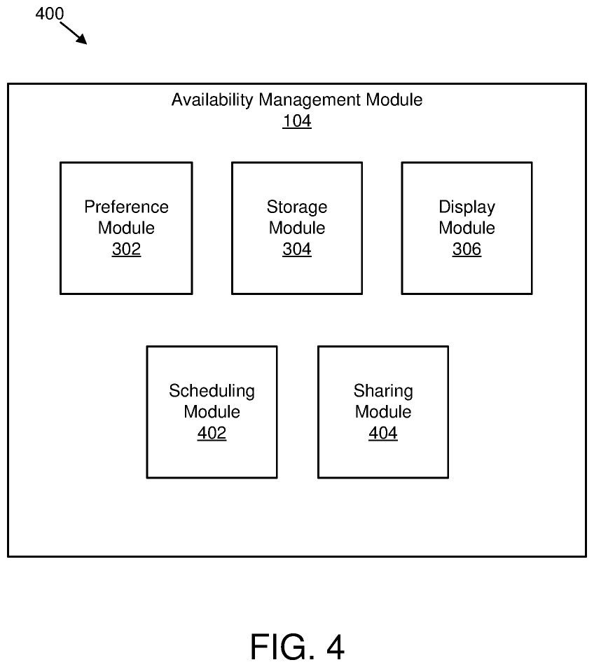

FIG. 4 is a schematic block diagram illustrating another embodiment of an apparatus 400 that includes one embodiment of the availability management module 104. Furthermore, the availability management module 104 includes one embodiment of the preference module 302, the storage module 304, and the display module 306, that may be substantially similar to the preference module 302, the storage module 304, and the display module 306 described in relation to FIG. 3. The availability management module 104 also includes a scheduling module 402 and a sharing module 404.

The scheduling module 402 may schedule and/or facilitate scheduling a meeting for the user based at least partly on the information. In some embodiments, scheduling the meeting for the user based at least partly on the information includes indicating a recommended meeting date, a recommended meeting day, a recommended meeting time, and/or a recommended meeting location based at least partly on the information. In such embodiments, the recommendations may be displayed to the user to enable the user to select a meeting date, a meeting day, a meeting time, and/or a meeting location. In various embodiments, facilitating scheduling a meeting may include automatically scheduling a meeting based at least partly on the information. In certain embodiments, the scheduling module 402 may factor in travel time to meeting locations and/or a likelihood that a particular meeting is to last longer than scheduled. In some embodiments, the scheduling module 402 may enable a user to pick a date, day, time, and/or location that facilitates all or most attendees being available.

The sharing module 404 may share the information indicating the meeting preferences corresponding to the user in the calendar software application with other users of the calendar software application.

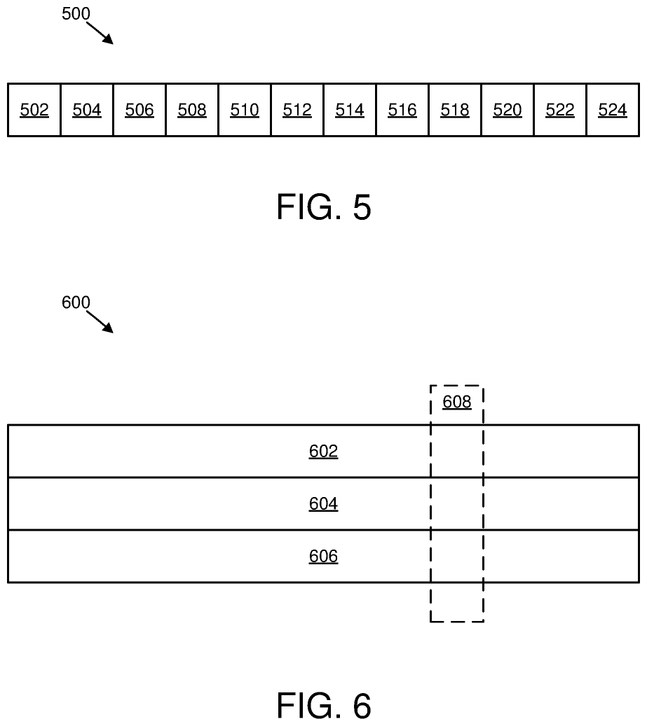

FIG. 5 is a schematic block diagram illustrating one embodiment of a displayed calendar 500. The displayed calendar 500 may be one embodiment of the display module 306 displaying the information indicating the meeting preference corresponding to the user in the calendar software application. The displayed calendar 500 may be for a particular day, date, and location and includes a first time period 502 (e.g., 7:00 am-8:00 am) having a corresponding likelihood of meeting acceptance displayed (e.g., “1” or red indicating that it is highly likely that a user will reject a meeting invitation), a second time period 504 (e.g., 8:00 am-9:00 am) having a corresponding likelihood of meeting acceptance displayed (e.g., “4” or orange indicating that it is more likely that a user will reject a meeting invitation than accept the meeting invitation), a third time period 506 (e.g., 9:00 am-10:00 am) having a corresponding likelihood of meeting acceptance displayed (e.g., “10” or green indicating that it is highly likely that a user will accept a meeting invitation), a fourth time period 508 (e.g., 10:00 am-11:00 am) having a corresponding likelihood of meeting acceptance displayed (e.g., “9” or color transitioning from green toward yellow indicating less of a likelihood that a user will accept a meeting invitation than a “10”), a fifth time period 510 (e.g., 11:00 am-12:00 pm) having a corresponding likelihood of meeting acceptance displayed (e.g., “8” or color transitioning from green toward yellow indicating less of a likelihood that a user will accept a meeting invitation than a “9”), a sixth time period 512 (e.g., 12:00 pm-1:00 pm) having a corresponding likelihood of meeting acceptance displayed (e.g., “7” or color transitioning from green toward yellow indicating less of a likelihood that a user will accept a meeting invitation than an “8”), a seventh time period 514 (e.g., 1:00 pm-2:00 pm) having a corresponding likelihood of meeting acceptance displayed (e.g., “6” or yellow indicating less of a likelihood that a user will accept a meeting invitation than a “7”), an eighth time period 516 (e.g., 2:00 pm-3:00 pm) having a corresponding likelihood of meeting acceptance displayed (e.g., “5” or color transitioning from yellow toward orange indicating less of a likelihood that a user will accept a meeting invitation than a “6”), a ninth time period 518 (e.g., 3:00 pm-4:00 pm) having a corresponding likelihood of meeting acceptance displayed (e.g., “4” or orange indicating less of a likelihood that a user will accept a meeting invitation than a “5”), a tenth time period 520 (e.g., 4:00 pm-5:00 pm) having a corresponding likelihood of meeting acceptance displayed (e.g., “3” or color transitioning from orange toward red indicating less of a likelihood that a user will accept a meeting invitation than a “4”), an eleventh time period 522 (e.g., 5:00 pm-6:00 pm) having a corresponding likelihood of meeting acceptance displayed (e.g., “2” or color transitioning from orange toward red indicating less of a likelihood that a user will accept a meeting invitation than a “3”), and a twelfth time period 524 (e.g., 6:00 pm-7:00 pm) having a corresponding likelihood of meeting acceptance displayed (e.g., “1” or red indicating that it is highly likely that a user will reject a meeting invitation).

FIG. 6 is a schematic block diagram illustrating one embodiment of a calendar scheduling 600. The calendar scheduling 600 may illustrate one embodiment of functions performed by the scheduling module 402 for scheduling and/or facilitating scheduling a meeting for a user based at least partly on information. The calendar scheduling 600 includes a first user's calendar 602, a second user's calendar 604, and a third user's calendar 604. The calendar scheduling 600 may indicate how likely certain dates, days, times, and/or locations are likely for corresponding users to accept a meeting invitation. A suggested meeting date, day, time, and/or location 608 may be indicated to a user scheduling a meeting to facilitate the user scheduling a meeting based on meeting preferences corresponding to the users. As may be appreciated, each of the calendars 602, 604, and 606 may have indicators similar to those described in relation to FIG. 5.

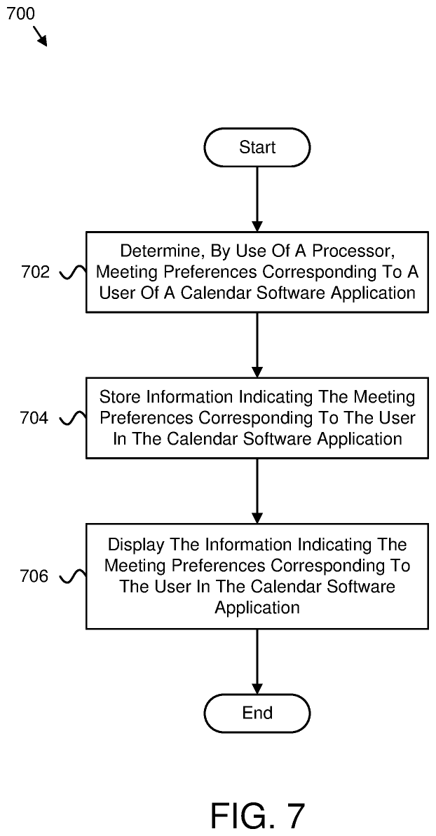

FIG. 7 is a schematic flow chart diagram illustrating an embodiment of a method 700 for indicating meeting preferences. In some embodiments, the method 700 is performed by an apparatus, such as the information handling device 102. In other embodiments, the method 700 may be performed by a module, such as the availability management module 104. In certain embodiments, the method 700 may be performed by a processor executing program code, for example, a microcontroller, a microprocessor, a CPU, a GPU, an auxiliary processing unit, a FPGA, or the like.

The method 700 may include determining 702, by use of a processor (e.g., the processor 202), meeting preferences corresponding to a user of a calendar software application. In certain embodiments, the preference module 302 may determine 702 the meeting preferences corresponding to a user of a calendar software application.

In some embodiments, determining 702 the meeting preferences corresponding to the user includes determining a likelihood that the user will accept a meeting invitation for a date, a day, a time, and/or a location. In various embodiments, determining 702 the likelihood that the user will accept a meeting invitation for a date, a day, a time, and/or a location includes determining the likelihood that the user will accept a meeting invitation for a date, a day, a time, and/or a location based on historical meeting acceptance data corresponding to the user.

In certain embodiments, determining 702 the likelihood that the user will accept a meeting invitation for a date, a day, a time, and/or a location by determining the likelihood that the user will accept a meeting invitation for a date, a day, a time, and/or a location based on settings selected by the user. In some embodiments, determining 702 the meeting preferences corresponding to the user includes determining the meeting preferences heuristically.

The method 700 may include storing 704 information indicating the meeting preferences corresponding to the user in the calendar software application. In some embodiments, the storage module 304 may store 704 the information indicating the meeting preferences corresponding to the user in the calendar software application.

The method 700 may include displaying 706 the information indicating the meeting preferences corresponding to the user in the calendar software application, and the method 700 may end. In some embodiments, the display module 306 may display 706 the information indicating the meeting preferences corresponding to the user in the calendar software application.

In certain embodiments, displaying 706 the information indicating the meeting preferences corresponding to the user in the calendar software application includes displaying the information using a color indicator to indicate a likelihood that the user will accept a meeting invitation for a date, a day, a time, and/or a location. In various embodiments, displaying 706 the information indicating the meeting preferences corresponding to the user in the calendar software application includes displaying the information using a numeric indicator, and/or an alphabetic indicator to indicate a likelihood that the user will accept a meeting invitation for a date, a day, a time, and/or a location.

In some embodiments, the availability management module 104 may schedule a meeting for the user based at least partly on the information. In certain embodiments, scheduling the meeting for the user based at least partly on the information includes indicating a recommended meeting date, a recommended meeting day, a recommended meeting time, and/or a recommended meeting location based at least partly on the information.

In various embodiments, the meeting preferences include date preferences, day preferences, time preferences, and/or location preferences. In some embodiments, the availability management module 104 may share the information indicating the meeting preferences corresponding to the user in the calendar software application with other users of the calendar software application.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
determine, by use of the processor, meeting preferences corresponding to a user of a calendar software application, wherein the meeting preferences comprise:
a likelihood that the user will accept a meeting invitation for a date, a day, a time, a location, or some combination thereof, wherein:
the likelihood that the user will accept the meeting invitation is determined using historical meeting acceptance data that comprises information corresponding to instances for which the user made a decision about whether to accept a received meeting invitation, decline a received meeting invitation, reschedule a received meeting invitation, or some combination thereof; and
the historical acceptance data comprises the following for each received meeting invitation of a plurality of received meeting invitations:
a length of a meeting corresponding to the received meeting invitation, a time of the meeting, a date of the meeting, a day of the meeting, a location of the meeting, or some combination thereof; and
an indicator indicating the decision of the user for the received meeting invitation, wherein the decision comprises an acceptance, a decline, or a meeting reschedule;
store information indicating the meeting preferences corresponding to the user in the calendar software application; and
display the information indicating the meeting preferences corresponding to the user in the calendar software application, wherein displaying the information comprises displaying the likelihood that the user will accept a meeting invitation using a color indicator, a numeric indicator, an alphabetic indicator, or some combination thereof.

2. (canceled)

3. The apparatus of claim 1, wherein the code is executable by the processor to determine the likelihood that the user will accept a meeting invitation for a date, a day, a time, a location, or a combination thereof by determining the likelihood that the user will accept a meeting invitation for a date, a day, a time, a location, or some combination thereof based on historical patterns corresponding to the user.

4. (canceled)

5. The apparatus of claim 1, wherein the code is executable by the processor to determine the likelihood that the user will accept a meeting invitation for a date, a day, a time, a location, or a combination thereof by determining the likelihood that the user will accept a meeting invitation for a date, a day, a time, a location, or some combination thereof based on settings selected by the user.

6. A method comprising:
determining, by use of a processor, meeting preferences corresponding to a user of a calendar software application, wherein the meeting preferences comprise:
a likelihood that the user will accept a meeting invitation for a date, a day, a time, a location, or some combination thereof, wherein:
the likelihood that the user will accept the meeting invitation is determined using historical meeting acceptance data that comprises information corresponding to instances for which the user made a decision about whether to accept a received meeting invitation, decline a received meeting invitation, reschedule a received meeting invitation, or some combination thereof; and
the historical acceptance data comprises the following for each received meeting invitation of a plurality of received meeting invitations:
a length of a meeting corresponding to the received meeting invitation, a time of the meeting, a date of the meeting, a day of the meeting, a location of the meeting, or some combination thereof; and
an indicator indicating the decision of the user for the received meeting invitation, wherein the decision comprises an acceptance, a decline, or a meeting reschedule;
storing information indicating the meeting preferences corresponding to the user in the calendar software application; and
displaying the information indicating the meeting preferences corresponding to the user in the calendar software application, wherein displaying the information comprises displaying the likelihood that the user will accept a meeting invitation using a color indicator, a numeric indicator, an alphabetic indicator, or some combination thereof.

7. (canceled)

8. The method of claim 6, wherein determining the likelihood that the user will accept a meeting invitation for a date, a day, a time, a location, or a combination thereof comprises determining the likelihood that the user will accept a meeting invitation for a date, a day, a time, a location, or some combination thereof based on historical meeting acceptance data corresponding to the user.

9. The method of claim 6, wherein determining the likelihood that the user will accept a meeting invitation for a date, a day, a time, a location or some combination thereof comprises determining the likelihood that the user will accept a meeting invitation for a date, a day, a time, a location or some combination thereof based on settings selected by the user.

10. The method of claim 6, wherein determining the meeting preferences corresponding to the user comprises determining the meeting preferences heuristically.

11. The method of claim 6, wherein displaying the information indicating the meeting preferences corresponding to the user in the calendar software application comprises displaying the information using the color indicator to indicate the likelihood that the user will accept a meeting invitation for a date, a day, a time, a location, or some combination thereof.

12. The method of claim 6, wherein displaying the information indicating the meeting preferences corresponding to the user in the calendar software application comprises displaying the information using the numeric indicator, the alphabetic indicator, or a combination thereof to indicate the likelihood that the user will accept a meeting invitation for a date, a day, a time, a location, or some combination thereof.

13. The method of claim 6, further comprising scheduling a meeting for the user based at least partly on the information.

14. The method of claim 13, wherein scheduling the meeting for the user based at least partly on the information comprises indicating a recommended meeting date, a recommended meeting day, a recommended meeting time, a recommended meeting location, or some combination thereof based at least partly on the information.

15. The method of claim 6, wherein the meeting preferences comprise date preferences, day preferences, time preferences, location preferences, or some combination thereof.

16. The method of claim 6, further comprising sharing the information indicating the meeting preferences corresponding to the user in the calendar software application with other users of the calendar software application.

17. A program product comprising a computer readable storage medium that stores code executable by a processor, the executable code comprising code to perform:
determining, by use the processor, meeting preferences corresponding to a user of a calendar software application, wherein the meeting preferences comprise:
a likelihood that the user will accept a meeting invitation for a date, a day, a time, a location, or some combination thereof, wherein:
the likelihood that the user will accept the meeting invitation is determined using historical meeting acceptance data that comprises information corresponding to instances for which the user made a decision about whether to accept a received meeting invitation, decline a received meeting invitation,
reschedule a received meeting invitation, or some combination thereof and the historical acceptance data comprises the following for each received meeting invitation of a plurality of received meeting invitations:
a length of a meeting corresponding to the received meeting invitation, a time of the meeting, a date of the meeting, a day of the meeting, a location of the meeting, or some combination thereof, and
an indicator indicating the decision of the user for the received meeting invitation, wherein the decision comprises an acceptance, a decline, or a meeting reschedule;
storing information indicating the meeting preferences corresponding to the user in the calendar software application; and
displaying the information indicating the meeting preferences corresponding to the user in the calendar software application, wherein displaying the information comprises displaying the likelihood that the user will accept a meeting invitation using a color indicator, a numeric indicator, an alphabetic indicator, or some combination thereof.

18. The program product of claim 17, wherein the executable code comprises code to perform displaying the information indicating the meeting preferences corresponding to the user in the calendar software application by displaying the information using the color indicator to indicate the likelihood that the user will accept a meeting invitation for a date, a day, a time, a location, or some combination thereof.

19. The program product of claim 17, wherein the executable code comprises code to perform displaying the information indicating the meeting preferences corresponding to the user in the calendar software application by displaying the information using the numeric indicator, the alphabetic indicator, or a combination thereof to indicate the likelihood that the user will accept a meeting invitation for a date, a day, a time, a location, or some combination thereof.

20. The program product of claim 17, wherein the meeting preferences comprise date preferences, day preferences, time preferences, location preferences, or some combination thereof.
